(19) United States
(12) Patent Application Publication
(10) Pub. No.: US 2026/0142061 A1
(43) Pub. Date: May 21, 2026

(54) CHIP RESISTOR

(71) Applicant: ROHM CO., LTD., Kyoto-shi (JP)

(72) Inventor: Takanori SHINOURA, Kyoto-shi (JP)

(21) Appl. No.: 19/442,317

(22) Filed: Jan. 7, 2026

Related U.S. Application Data
(63) Continuation of application No. PCT/JP2024/020148, filed on Jun. 3, 2024.

(30) Foreign Application Priority Data
Jul. 14, 2023 (JP) 2023-115784

(51) Int. Cl. H01C 1/14

(52) U.S. Cl. CPC H01C 1/14

(57) ABSTRACT

A chip resistor includes an insulating substrate, a resistance element, a rear-surface electrode, and a side-surface electrode. The insulating substrate includes a rear surface and a side surface. The resistance element and the rear-surface electrode are arranged at the rear surface. The side-surface electrode is arranged on the side surface and the rear-surface electrode. The side-surface electrode includes a lowermost point arranged at a position most distant from the rear surface in a direction perpendicular to the rear surface. The side-surface electrode includes a lowermost surface inclined with respect to the rear surface. The lowermost surface is an area from the side surface to the lowermost point. The lowermost surface includes a first area including the lowermost point. In the first area, an angle of inclination of the lowermost surface with respect to the rear surface is larger than or equal to 1° and smaller than or equal to 10°.

### TECHNICAL FIELD

The present disclosure relates to a chip resistor.

### BACKGROUND ART

Japanese Patent Laying-Open No. 2022-105204 (PTL 1) discloses a chip resistor including a substrate, a resistance element layer, a protection layer, a conductor layer, a rear-surface electrode layer, and a plated layer. The chip resistor is mounted on a wiring board with a conductive joint member such as solder being interposed.

### CITATION LIST

### Patent Literature

PTL 1: Japanese Patent Laying-Open No. 2022-105204

### BRIEF DESCRIPTION OF DRAWINGS

FIG. 1 is a schematic plan view of a chip resistor in a first embodiment.

FIG. 2 is a schematic cross-sectional view along the line segment II-II shown in FIG. 1.

FIG. 3 is a partially enlarged cross-sectional view in an area III shown in FIG. 2.

FIG. 4 is a partially enlarged cross-sectional view in a modification of the chip resistor in the first embodiment.

FIG. 5 is a partially enlarged cross-sectional view in a modification of the chip resistor in the first embodiment.

FIG. 6 is a partial cross-sectional view of the chip resistor after a temperature cycle test in a Comparative Example.

FIG. 7 is a partial cross-sectional view of the chip resistor after the temperature cycle test in an Example.

FIG. 8 is a schematic cross-sectional view of the chip resistor in a second embodiment.

FIG. 9 is a schematic cross-sectional view of the chip resistor in a third embodiment.

FIG. 10 is a schematic cross-sectional view of the chip resistor in a fourth embodiment.

FIG. 11 is a schematic cross-sectional view of the chip resistor in a fifth embodiment.

FIG. 12 is a schematic cross-sectional view of the chip resistor in a sixth embodiment.

FIG. 13 is a schematic cross-sectional view of the chip resistor in a seventh embodiment.

FIG. 14 is a schematic cross-sectional view of the chip resistor in an eighth embodiment.

FIG. 15 is a schematic cross-sectional view of the chip resistor in a ninth embodiment.

FIG. 16 is a schematic cross-sectional view of the chip resistor in a tenth embodiment.

FIG. 17 is a schematic cross-sectional view of the chip resistor in an eleventh embodiment.

FIG. 18 is a schematic cross-sectional view of the chip resistor in a twelfth embodiment.

### DETAILED DESCRIPTION

Details of an embodiment of the present disclosure will be described with reference to the drawings. The same or corresponding elements in the drawings below have the same reference characters allotted and description thereof will not be repeated. At least one feature in the embodiment which will be described below may freely be combined.

### First Embodiment

### <Configuration of Chip Resistor>

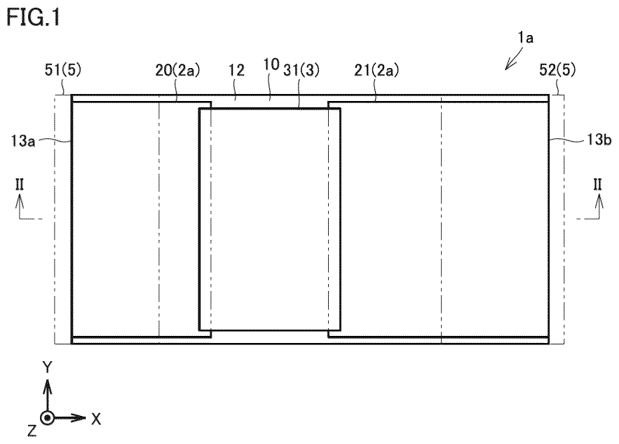

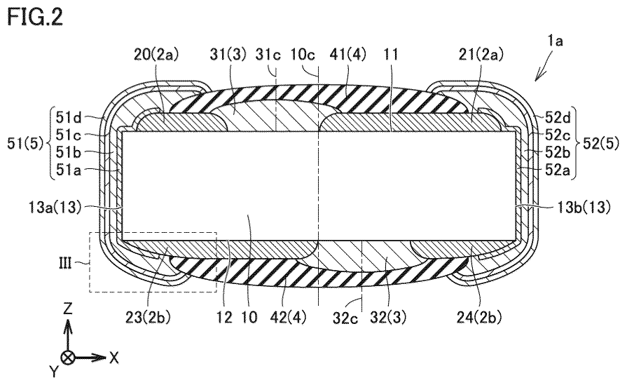

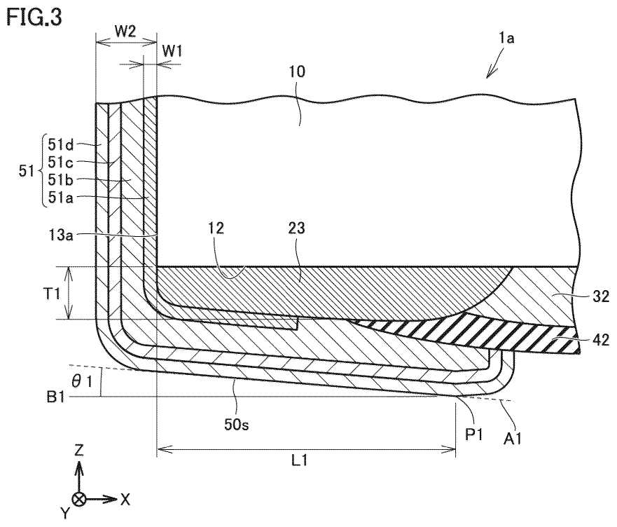

FIG. 1 is a schematic plan view of a chip resistor in a first embodiment. FIG. 2 is a schematic cross-sectional view along the line segment II-II shown in FIG. 1. FIG. 3 is a partially enlarged cross-sectional view in an area III shown in FIG. 2.

A chip resistor 1a includes an insulating substrate 10, a resistance element 3, an insulating protective film 4, a front-surface electrode 2a, a rear-surface electrode 2b, and a side-surface electrode 5. Insulating substrate 10 is formed, for example, of a ceramic material such as alumina (Al₂O₃). Insulating substrate 10 includes a front surface 11, a rear surface 12, and a side surface 13. Rear surface 12 is a surface opposite to front surface 11. Side surface 13 connects front surface 11 and rear surface 12 to each other. Side surface 13 includes a first side surface 13a and a second side surface 13b. Second side surface 13b is a surface opposite to first side surface 13a. In other words, each of first side surface 13a and second side surface 13b connects front surface 11 and rear surface 12 to each other.

A direction perpendicular to side surface 13 is defined as an X direction. A direction perpendicular to front surface 11 and rear surface 12 is defined as a Z direction. A direction perpendicular to each of the X direction and the Z direction is defined as a Y direction. The X direction is a longitudinal direction of insulating substrate 10 in FIG. 2. The Z direction is a thickness direction of insulating substrate 10. Front surface 11 and rear surface 12 are opposing end surfaces in the thickness direction (Z direction) of insulating substrate 10. Rear surface 12 is a surface (mount surface) opposed to a circuit substrate (not shown) when chip resistor 1a is mounted on the circuit substrate. First side surface 13a and second side surface 13b are opposing end surfaces in the longitudinal direction (X direction) of insulating substrate 10.

Resistance element 3 is arranged at at least one of front surface 11 and rear surface 12. In the present first embodiment, resistance element 3 includes a first resistance element 31 and a second resistance element 32. Resistance element 3 is, for example, a CuNi resistance element or the like.

First resistance element 31 is arranged on front surface 11. A center 31c of first resistance element 31 in the longitudinal direction (X direction) of insulating substrate 10 does not have to coincide, for example, with a center 10c of insulating substrate 10 in the longitudinal direction of insulating substrate 10.

Second resistance element 32 is arranged on rear surface 12. A center 32c of second resistance element 32 in the longitudinal direction (X direction) of insulating substrate 10 does not have to coincide, for example, with center 10c of insulating substrate 10 in the longitudinal direction of insulating substrate 10. In the longitudinal direction (X direction), center 31c of first resistance element 31 does not have to coincide with center 32c of second resistance element 32.

Front-surface electrode 2a is arranged on front surface 11. Front-surface electrode 2a includes a first front-surface electrode 20 and a second front-surface electrode 21. First front-surface electrode 20 and second front-surface electrode 21 are connected to first resistance element 31. In a plan view of front surface 11, second front-surface electrode 21 is arranged at a distance in the X direction from first front-surface electrode 20. First front-surface electrode 20 is arranged closer to first side surface 13a than second front-surface electrode 21. Second front-surface electrode 21 is arranged closer to second side surface 13b than first front-surface electrode 20. In other words, first front-surface electrode 20 and second front-surface electrode 21 are arranged such that first resistance element 31 lies therebetween in the X direction. Front-surface electrode 2a is, for example, a Cu electrode, an Ag electrode, or the like.

Rear-surface electrode 2b is arranged on rear surface 12. Rear-surface electrode 2b includes a first rear-surface electrode 23 and a second rear-surface electrode 24. First rear-surface electrode 23 and second rear-surface electrode 24 are connected to second resistance element 32. In the plan view of rear surface 12, second rear-surface electrode 24 is arranged at a distance in the X direction from first rear-surface electrode 23. First rear-surface electrode 23 is arranged closer to first side surface 13a than second rear-surface electrode 24. Second rear-surface electrode 24 is arranged closer to second side surface 13b than first rear-surface electrode 23. In other words, first rear-surface electrode 23 and second rear-surface electrode 24 are arranged such that second resistance element 32 lies therebetween in the X direction.

Rear-surface electrode 2b is, for example, a Cu electrode, an Ag electrode, or the like. First rear-surface electrode 23 and second rear-surface electrode 24 are formed, for example, of a conductive material the same as that for first front-surface electrode 20 and second front-surface electrode 21.

As will be described later, front-surface electrode 2a and rear-surface electrode 2b may each be composed of a plurality of layers, and may each be composed, for example, of two layers or three layers.

Insulating protective film 4 is arranged on resistance element 3. Insulating protective film 4 includes a first insulating protective film 41 and a second insulating protective film 42. First insulating protective film 41 is arranged on first resistance element 31. First insulating protective film 41 is arranged also on first front-surface electrode 20 and second front-surface electrode 21. Second insulating protective film 42 is arranged on second resistance element 32. Second insulating protective film 42 is arranged also on first rear-surface electrode 23 and second rear-surface electrode 24. Insulating protective film 4 contains, for example, epoxy resin, phenol resin, or a mixture of epoxy resin and phenol resin.

Second resistance element 32 and second insulating protective film 42 should only be formed on rear surface 12, and as will be described later, first resistance element 31 and first insulating protective film 41 do not have to be arranged on front surface 11.

Side-surface electrode 5 is arranged on side surface 13, front-surface electrode 2a, and rear-surface electrode 2b. Side-surface electrode 5 includes a first side-surface electrode 51 and a second side-surface electrode 52.

First side-surface electrode 51 is arranged on first side surface 13a of insulating substrate 10, first front-surface electrode 20, and first rear-surface electrode 23. First front-surface electrode 20 electrically conducts to first rear-surface electrode 23 through first side-surface electrode 51. First side-surface electrode 51 includes a first layer 51a, a second layer 51b, a third layer 51c, and a fourth layer 51d.

First layer 51a is arranged on first side surface 13a of insulating substrate 10, first front-surface electrode 20, and first rear-surface electrode 23. First layer 51a is formed, for example, of a conductive material which is less likely to be sulfurized. First layer 51a is formed, for example, of an Ni—Cr alloy. First layer 51a is, for example, a sputtered layer. Though first layer 51a may be arranged on first insulating protective film 41 and second insulating protective film 42, first layer 51a is not arranged on first insulating protective film 41 and second insulating protective film 42 in the present first embodiment.

Second layer 51b is arranged on first front-surface electrode 20, first rear-surface electrode 23, and first layer 51a. Second layer 51b is, for example, a copper layer. Second layer 51b is connected to first insulating protective film 41 and second insulating protective film 42.

Third layer 51c is arranged on second layer 51b. Third layer 51c protects first front-surface electrode 20, first rear-surface electrode 23, first layer 51a, and second layer 51b against heat and shock. Third layer 51c is, for example, a nickel layer. Third layer 51c is connected to first insulating protective film 41 and second insulating protective film 42.

Fourth layer 51d is arranged on third layer 51c. Fourth layer 51d is formed of a material to which a conductive joint member 200 (not shown) such as solder readily adheres. Fourth layer 51d is, for example, a tin layer. Fourth layer 51d is connected to first insulating protective film 41 and second insulating protective film 42.

Second side-surface electrode 52 is arranged on second side surface 13b of insulating substrate 10, second front-surface electrode 21, and second rear-surface electrode 24. Second front-surface electrode 21 electrically conducts to second rear-surface electrode 24 through second side-surface electrode 52. Second side-surface electrode 52 includes a first layer 52a, a second layer 52b, a third layer 52c, and a fourth layer 52d.

First layer 52a is arranged on second side surface 13b of insulating substrate 10, second front-surface electrode 21, and second rear-surface electrode 24. First layer 52a is formed, for example, of a conductive material which is less likely to be sulfurized. First layer 52a is formed, for example, of an Ni—Cr alloy. First layer 52a is, for example, a sputtered layer. Though first layer 52a may be arranged on first insulating protective film 41 and second insulating protective film 42, first layer 52a is not arranged on first insulating protective film 41 and second insulating protective film 42 in the present first embodiment.

Second layer 52b is arranged on second front-surface electrode 21, second rear-surface electrode 24, and first layer 52a. Second layer 52b is, for example, a copper layer. Second layer 52b is connected to first insulating protective film 41 and second insulating protective film 42.

Third layer 52c is arranged on second layer 52b. Third layer 52c protects second front-surface electrode 21, second rear-surface electrode 24, first layer 52a, and second layer 52b against heat and shock. Third layer 52c is, for example, a nickel layer. Third layer 52c is connected to first insulating protective film 41 and second insulating protective film 42.

Fourth layer 52d is arranged on third layer 52c. Fourth layer 52d is formed of a material to which conductive joint member 200 such as solder readily adheres. Fourth layer 52d is, for example, a tin layer. Fourth layer 52d is connected to first insulating protective film 41 and second insulating protective film 42. Conductive joint member 200 (not shown) adheres to fourth layers 51d and 52d and an electrical wire (not shown) of wiring board 100 (not shown), so that chip resistor 1a is mounted on wiring board 100.

Chip resistor 1a according to the present first embodiment is characterized in that a lowermost surface 50s of side-surface electrode 5 is inclined with respect to rear surface 12. Specifically, as shown in FIG. 3, side-surface electrode 5 includes a lowermost point P1. Lowermost point P1 is arranged at a position most distant in the Z direction from rear surface 12. Side-surface electrode 5 includes lowermost surface 50s. Lowermost surface 50s is an area from side surface 13 to lowermost point P1. Lowermost surface 50s is inclined with respect to rear surface 12. Lowermost surface 50s includes a first area L1. First area L1 is an area distant in the X direction from side surface 13 and includes lowermost point P1. In first area L1, an angle of inclination θ1 of lowermost surface 50s with respect to rear surface 12 is larger than or equal to 1° and smaller than or equal to 10°.

Chip resistor 1a is mounted such that rear surface 12 is in parallel to a placement surface of wiring board 100 in mount of chip resistor 1a on wiring board 100 with conductive joint member 200 being interposed. When chip resistor 1a is mounted on wiring board 100 with such conductive joint member 200 being interposed, a crack 400 may occur between lowermost surface 50s and wiring board 100 due to thermal fatigue such as a temperature cycle.

Like chip resistor 1a according to the present first embodiment, by mounting chip resistor 1a on wiring board 100 such that lowermost surface 50s is inclined with respect to the placement surface of wiring board 100, concentration of stress caused by thermal fatigue and applied to conductive joint member 200 is mitigated. In other words, occurrence of crack 400 due to thermal fatigue between lowermost surface 50s and wiring board 100 is suppressed. Consequently, long-term reliability of chip resistor 1a is improved.

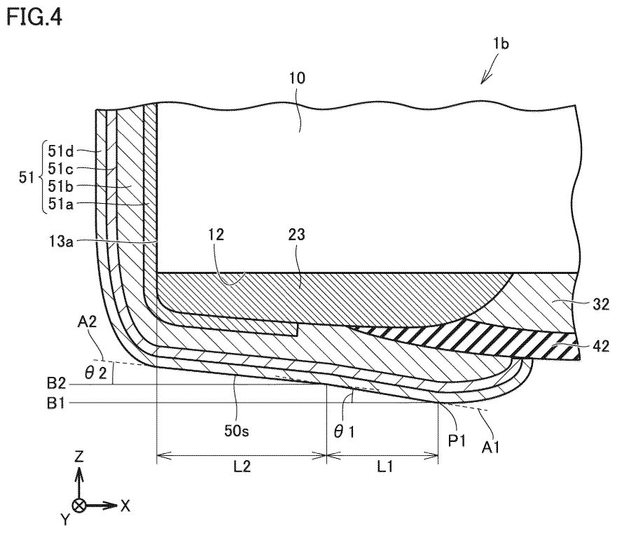

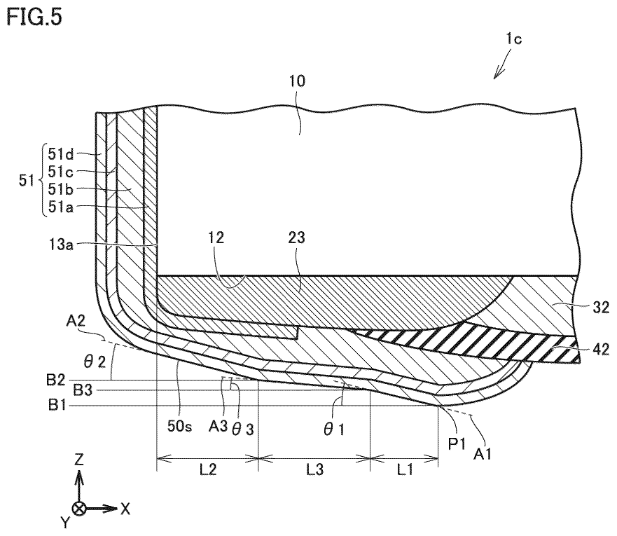

FIGS. 4 and 5 each show a modification of chip resistor 1a shown in FIGS. 1 to 3. Each of FIGS. 4 and 5 corresponds to FIG. 3. Though chip resistors 1b and 1c shown in FIGS. 4 and 5 are basically similar in configuration to chip resistor 1a shown in FIGS. 1 to 3, they are different in that lowermost surface 50s has a plurality of different angles of inclination θ. Specifically, lowermost surface 50s may include a second area L2. Second area L2 is arranged at a position closest to side surface 13 in the X direction. In second area L2, an angle of inclination θ2 of lowermost surface 50s with respect to rear surface 12 may be larger than or equal to 1°, and it is more preferably larger than or equal to 5°.

In chip resistor 1b according to the modification of the first embodiment shown in FIG. 4, in lowermost surface 50s, second area L2 is adjacent to first area L1. In the X direction, first area L1 has a width preferably larger than or equal to ½ a distance from side surface 13 to lowermost point P1. The width of first area L1 is a distance in the X direction from lowermost point P1 to a point of connection of first area L1 to second area L2.

Lowermost surface 50s may include a third area L3. In chip resistor 1c according to the modification of the first embodiment shown in FIG. 5, third area L3 is arranged between first area L1 and second area L2 in the X direction. In other words, first area L1 is arranged between lowermost point P1 and third area L3 in the X direction. Second area L2 is arranged between side surface 13 and third area L3 in the X direction. In third area L3, an angle of inclination θ3 of lowermost surface 50s with respect to rear surface 12 is preferably larger than or equal to 1° and smaller than or equal to 5°. In the X direction, the width of each of first area L1, second area L2, and third area L3 is preferably larger than or equal to ¼ and smaller than or equal to ½ the distance from side surface 13 to lowermost point P1.

When chip resistor 1a, 1b, or 1c is thus mounted on wiring board 100 such that lowermost surface 50s is inclined with respect to the placement surface of wiring board 100, concentration of stress caused by the temperature cycle and applied to conductive joint member 200 is mitigated. In other words, occurrence of crack 400 due to thermal fatigue between lowermost surface 50s and wiring board 100 is suppressed. Consequently, long-term reliability of chip resistor 1a is improved.

Angle of inclination θ will now be described. As shown in FIGS. 3 to 5, angle of inclination θ is an angle formed between an approximate line A1 and a parallel line B1, between an approximate line A2 and a parallel line B2, and between an approximate line A3 and a parallel line B3. Angle of inclination θ is a narrow angle. Parallel lines B1, B2, and B3 are lines in parallel to rear surface 12.

Approximate line A1 is a straight line calculated from successive points on lowermost surface 50s in first area L1. Approximate line A2 is a straight line calculated from successive points on lowermost surface 50s in second area L2. Approximate line A3 is a straight line calculated from successive points on lowermost surface 50s in third area L3. The successive points are captured from a photograph of a cross-section of chip resistor 1a. Approximate lines A1, A2, and A3 are calculated, for example, with a least square method from the successive points.

By calculating the angle formed between approximate line A1, A2, A3 thus calculated and parallel line B1, B2, B3, angles of inclination θ1, θ2, and θ3 are calculated.

If front-surface electrode 2a extends to side surface 13, in a stage of manufacturing of chip resistor 1a, a burr may be produced on side surface 13. Therefore, in the plan view viewed from the Z direction, preferably, front-surface electrode 2a does not extend to side surface 13.

Unless rear-surface electrode 2b extends to side surface 13, on the other hand, stress concentration occurs at a corner portion of insulating substrate 10 due to the temperature cycle. Consequently, crack 400 due to thermal fatigue may occur at the corner portion of insulating substrate 10. In order to lessen concentration of stress applied to the corner portion of insulating substrate 10, in the plan view viewed from the Z direction, rear-surface electrode 2b preferably extends to side surface 13.

In order to lessen concentration of stress applied to the corner portion of insulating substrate 10, a width W1 in the X direction of the sputtered layer is preferably larger than or equal to 10 nm. Specifically, as shown in FIG. 3, for example, width W1 in the X direction of first layer 51a is preferably larger than or equal to 10 nm.

In order to lessen concentration of stress applied to the corner portion of insulating substrate 10, a width W2 in the X direction of side-surface electrode 5 is preferably larger than or equal to 15 μm. Specifically, as shown in FIG. 3, for example, width W2 in the X direction of first side-surface electrode 51 is preferably larger than or equal to 15 μm.

In order to lessen concentration of stress applied to the corner portion of insulating substrate 10, as shown in FIG. 3, a thickness T1 in the Z direction of rear-surface electrode 2b is preferably larger than or equal to 5 μm. Thickness T1 is, for example, a distance from rear surface 12 to a point arranged at a position of rear-surface electrode 2b most distant in the Z direction.

### Functions and Effects

Chip resistor 1a according to the present disclosure includes insulating substrate 10, resistance element 3, rear-surface electrode 2b, and side-surface electrode 5. Insulating substrate 10 includes front surface 11, rear surface 12, and side surface 13. Rear surface 12 is arranged opposite to front surface 11. Side surface 13 connects front surface 11 and rear surface 12 to each other. Resistance element 3 is arranged at at least one of front surface 11 and rear surface 12. Rear-surface electrode 2b is arranged on rear surface 12. Side-surface electrode 5 is arranged on side surface 13 and rear-surface electrode 2b. The direction perpendicular to rear surface 12 is defined as the Z direction. Side-surface electrode 5 includes lowermost point P1. Lowermost point P1 is arranged at the position most distant in the Z direction from rear surface 12. Side-surface electrode 5 includes lowermost surface 50s. Lowermost surface 50s is the area from side surface 13 to lowermost point P1. Lowermost surface 50s is inclined with respect to rear surface 12. Lowermost surface 50s includes first area L1. First area L1 includes lowermost point P1. In first area L1, angle of inclination θ1 of lowermost surface 50s with respect to rear surface 12 is larger than or equal to 1° and smaller than or equal to 10°.

By thus mounting chip resistor 1a on wiring board 100 such that lowermost surface 50s is inclined with respect to the placement surface of wiring board 100, concentration of stress caused by the temperature cycle and applied to conductive joint member 200 is mitigated. In other words, occurrence of crack 400 due to thermal fatigue between lowermost surface 50s and wiring board 100 is suppressed. Consequently, long-term reliability of chip resistor 1a can be improved.

In chip resistor 1a, the direction perpendicular to side surface 13 is defined as the X direction. Lowermost surface 50s includes second area L2. Second area L2 is arranged at the position closest to side surface 13 in the X direction. In second area L2, angle of inclination θ2 of lowermost surface 50s with respect to rear surface 12 is larger than or equal to 5°.

Thus, even when lowermost surface 50s includes a plurality of different angles of inclination θ, concentration of stress caused by the temperature cycle and applied to conductive joint member 200 is mitigated. In other words, occurrence of crack 400 due to thermal fatigue between lowermost surface 50s and wiring board 100 is suppressed. Consequently, long-term reliability of chip resistor 1a can be improved.

In chip resistor 1a, lowermost surface 50s includes third area L3. Third area L3 is arranged between first area L1 and second area L2 in the X direction. In third area L3, angle of inclination θ3 of lowermost surface 50s with respect to rear surface 12 is larger than or equal to 1° and smaller than or equal to 5.

Thus, even when lowermost surface 50s includes a plurality of different angles of inclination θ, concentration of stress caused by the temperature cycle and applied to conductive joint member 200 is mitigated. In other words, occurrence of crack 400 due to thermal fatigue between lowermost surface 50s and wiring board 100 is suppressed. Consequently, long-term reliability of chip resistor 1a can be improved.

In chip resistor 1a, the width of first area L1 in the X direction is larger than or equal to ½ the distance from side surface 13 to lowermost point P1. Thus, even when lowermost surface 50s includes a plurality of different angles of inclination θ, concentration of stress caused by the temperature cycle and applied to conductive joint member 200 is mitigated. In other words, occurrence of crack 400 due to thermal fatigue between lowermost surface 50s and wiring board 100 is suppressed. Consequently, long-term reliability of chip resistor 1a can be improved.

In chip resistor 1a, in the plan view viewed from the Z direction, rear-surface electrode 2b extends to side surface 13. Thus, concentration of stress applied to the corner portion of insulating substrate 10 can be lessened. Consequently, long-term reliability of chip resistor 1a can be improved.

In chip resistor 1a, thickness T1 in the Z direction of rear-surface electrode 2b is larger than or equal to 5 μm. Thus, concentration of stress applied to the corner portion of insulating substrate 10 can be lessened. Consequently, long-term reliability of chip resistor 1a can be improved.

In chip resistor 1a, width W2 in the X direction of side-surface electrode 5 is larger than or equal to 15 μm. Thus, concentration of stress applied to the corner portion of insulating substrate 10 can be lessened. Consequently, long-term reliability of chip resistor 1a can be improved.

Chip resistor 1a further includes front-surface electrode 2a and insulating protective film 4. Front-surface electrode 2a is arranged on front surface 11. Insulating protective film 4 includes first insulating protective film 41 and second insulating protective film 42. Side surface 13 includes first side surface 13a and second side surface 13b. Second side surface 13b is arranged opposite to first side surface 13a. Resistance element 3 includes first resistance element 31 and second resistance element 32. First resistance element 31 is arranged on front surface 11. Second resistance element 32 is arranged on rear surface 12. Front-surface electrode 2a includes first front-surface electrode 20 and second front-surface electrode 21. Second front-surface electrode 21 is arranged at a distance in the X direction from first front-surface electrode 20. Rear-surface electrode 2b includes first rear-surface electrode 23 and second rear-surface electrode 24. Second rear-surface electrode 24 is arranged at a distance in the X direction from first rear-surface electrode 23. Side-surface electrode 5 includes first side-surface electrode 51 and second side-surface electrode 52. First side-surface electrode 51 is arranged on first side surface 13a, first rear-surface electrode 23, and first front-surface electrode 20. Second side-surface electrode 52 is arranged on second side surface 13b, second rear-surface electrode 24, and second front-surface electrode 21. First insulating protective film 41 is arranged on first resistance element 31, first front-surface electrode 20, and second front-surface electrode 21. Second insulating protective film 42 is arranged on second resistance element 32, first rear-surface electrode 23, and second rear-surface electrode 24.

Thus, when chip resistor 1a is mounted on wiring board 100 such that lowermost surface 50s is inclined with respect to the placement surface of wiring board 100, concentration of stress caused by the temperature cycle and applied to conductive joint member 200 is mitigated. In other words, occurrence of crack 400 due to thermal fatigue between lowermost surface 50s and wiring board 100 is suppressed. Consequently, long-term reliability of chip resistor 1a can be improved.

In order to verify effects of chip resistor 1a, 1b, or 1c according to the present first embodiment as above, whether or not crack 400 occurred was investigated in a temperature cycle test.

### <Temperature Cycle Test>

The temperature cycle test is a test in which a cycle of placement of the chip resistor in a low-temperature environment at −55° C. for 30 minutes and following placement thereof in a high-temperature environment at 150° C. for 30 minutes is repeated. Chip resistors in Examples 1 to 9 and Comparative Example 1 are subjected to the temperature cycle test. Tables 1 to 3 show angles of inclination θ of the chip resistors in Examples 1 to 9 and Comparative Example 1. Examples 1 to 4 are similar in configuration to chip resistor 1a according to the present first embodiment. Examples 5 to 7 are similar in configuration to chip resistor 1b according to the present first embodiment. Examples 8 and 9 are similar in configuration to chip resistor 1c according to the present first embodiment. In other words, angles of inclination θ1 in Examples 1 to 9 are larger than or equal to 1° and smaller than or equal to 10°. Angles of inclination θ2 in Examples 5 to 9 are larger than or equal to 5°. Angles of inclination θ3 in Examples 8 and 9 are larger than or equal to 1° and smaller than or equal to 5°. In Comparative Example 1, lowermost surface 50s of the chip resistor is in parallel to rear surface 12. In other words, angle of inclination θ in Comparative Example 1 is 0°. Angles of inclination θ shown in Tables 1 to 3 are the angles of inclination on a side of first side surface 13a.

TABLE 1

| | Comparative | | | | |
|---|---|---|---|---|---|
| | Example 1 | Example 1 | Example 2 | Example 3 | Example 4 |
| Angle of | 0 | 3.5 | 4 | 4.5 | 2 |
| Inclination | | | | | |
| θ1 [°] | | | | | |

TABLE 2

| | Example 5 | Example 6 | Example 7 |
|---|---|---|---|
| Angle of Inclination θ1 [°] | 1.5 | 2.9 | 2.5 |
| Angle of Inclination θ2 [°] | 9 | 9 | 9 |

TABLE 3

| | Example 8 | Example 9 |
|---|---|---|
| Angle of Inclination θ1 [°] | 8 | 3 |
| Angle of Inclination θ2 [°] | 11 | 13 |
| Angle of Inclination θ3 [°] | 3.5 | 1 |

### <Results of Test>

In the temperature cycle test, in Examples 1 to 9, no crack 400 occurred between lowermost surface 50s and wiring board 100 in the vicinity of lowermost surface 50s. In Comparative Example 1, on the other hand, crack 400 occurred between lowermost surface 50s and wiring board 100 in the vicinity of lowermost surface 50s. When crack 400 occurs, a resistance value of the chip resistor greatly varies. Therefore, long-term reliability of the chip resistor may be checked by measuring an amount of variation in resistance value of the chip resistor.

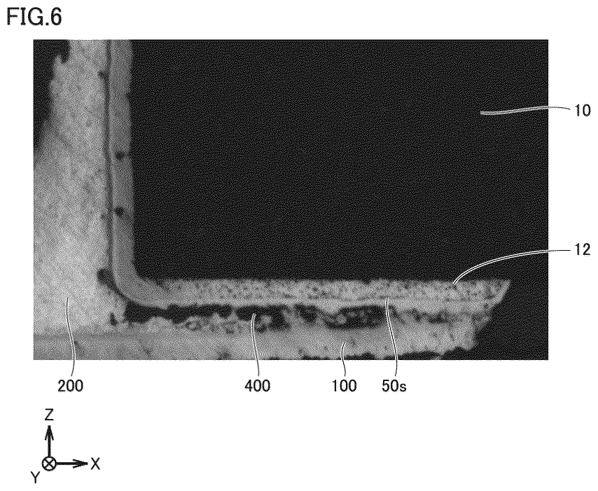

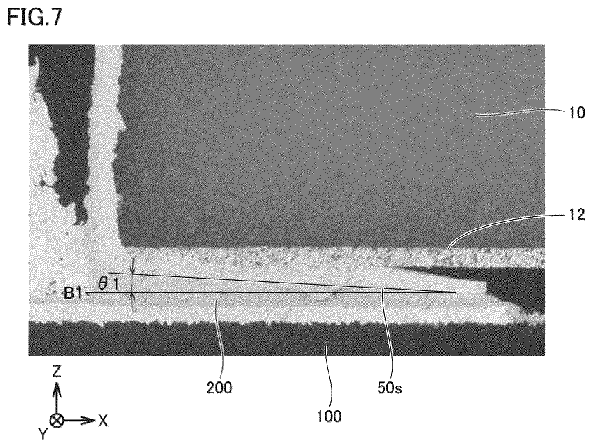

FIGS. 6 and 7 show the chip resistors after the temperature cycle test. FIG. 6 is a partial cross-sectional view of the chip resistor after the temperature cycle test in Comparative Example 1. FIG. 7 is a partial cross-sectional view of the chip resistor after the temperature cycle test in Example 1.

As shown in FIG. 6, in Comparative Example 1, crack 400 occurred between lowermost surface 50s and wiring board 100. As shown in FIG. 7, on the other hand, in Example 1, no crack 400 occurred between lowermost surface 50s and wiring board 100. In other words, long-term reliability of the chip resistor can be improved by inclination of lowermost surface 50s with respect to rear surface 12.

### Second Embodiment

### <Configuration of Chip Resistor>

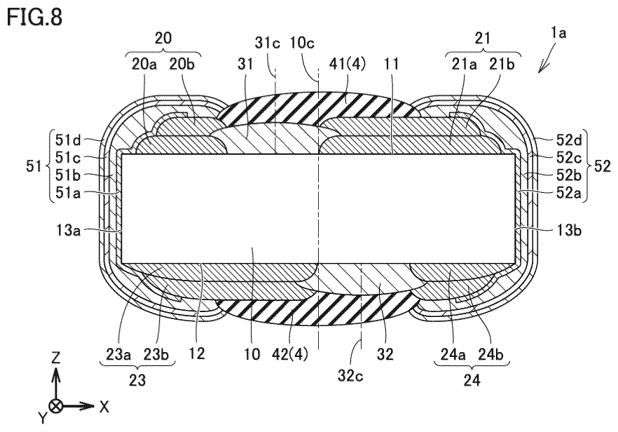

FIG. 8 is a schematic cross-sectional view of chip resistor 1a in a second embodiment. FIG. 8 corresponds to FIG. 2. Though chip resistor 1a shown in FIG. 8 is basically similar in configuration and effect to chip resistor 1a shown in FIGS. 1 to 3, it is different in that each of front-surface electrode 2a and rear-surface electrode 2b is composed of two layers. According to such a configuration, control of angle of inclination θ is facilitated. As each of front-surface electrode 2a and rear-surface electrode 2b is composed of two layers, the resistance value of front-surface electrode 2a and rear-surface electrode 2b decreases. Therefore, a temperature coefficient of resistance of chip resistor 1a decreases. Since the resistance value of chip resistor 1a is small, accuracy in measurement of the resistance value in probing improves.

Specifically, for example, first front-surface electrode 20 includes a first electrode layer 20a and a second electrode layer 20b. First front-surface electrode 20 is a multilayer body of first electrode layer 20a and second electrode layer 20b. First electrode layer 20a is arranged on front surface 11. A part of first resistance element 31 is arranged on first electrode layer 20a. Second electrode layer 20b is arranged on first electrode layer 20a. A part of second electrode layer 20b is arranged on first resistance element 31.

Second front-surface electrode 21 includes a first electrode layer 21a and a second electrode layer 21b. Second front-surface electrode 21 is a multilayer body of first electrode layer 21a and second electrode layer 21b. First electrode layer 21a is arranged on front surface 11. A part of first resistance element 31 is arranged on first electrode layer 21a. Second electrode layer 21b is arranged on first electrode layer 21a. A part of second electrode layer 21b is arranged on first resistance element 31.

First rear-surface electrode 23 includes a first electrode layer 23a and a second electrode layer 23b. First rear-surface electrode 23 is a multilayer body of first electrode layer 23a and second electrode layer 23b. First electrode layer 23a is arranged on rear surface 12. A part of second resistance element 32 is arranged on first electrode layer 23a. Second electrode layer 23b is arranged on first electrode layer 23a. A part of second electrode layer 23b is arranged on second resistance element 32.

Second rear-surface electrode 24 includes a first electrode layer 24a and a second electrode layer 24b. Second rear-surface electrode 24 is a multilayer body of first electrode layer 24a and second electrode layer 24b. First electrode layer 24a is arranged on rear surface 12. A part of second resistance element 32 is arranged on first electrode layer 24a. Second electrode layer 24b is arranged on first electrode layer 24a. A part of second electrode layer 24b is arranged on second resistance element 32.

### Third Embodiment

### <Configuration of Chip Resistor>

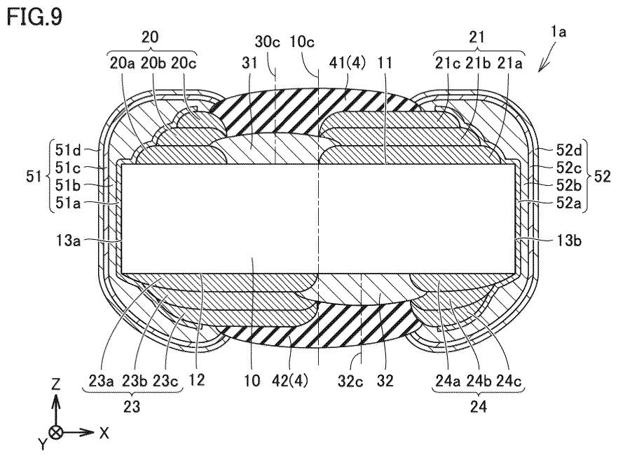

FIG. 9 is a schematic cross-sectional view of chip resistor 1a in a third embodiment. FIG. 9 corresponds to FIG. 2. Though chip resistor 1a shown in FIG. 9 is basically similar in configuration and effect to chip resistor 1a shown in FIGS. 1 to 3, it is different in that each of front-surface electrode 2a and rear-surface electrode 2b is composed of three layers. According to such a configuration, control of angle of inclination θ is further facilitated. As each of front-surface electrode 2a and rear-surface electrode 2b is composed of three layers, the resistance value of front-surface electrode 2a and rear-surface electrode 2b decreases. Therefore, the temperature coefficient of resistance of chip resistor 1a decreases. Since the resistance value of chip resistor 1a is small, accuracy in measurement of the resistance value in probing improves.

Specifically, for example, first front-surface electrode 20 includes first electrode layer 20a, second electrode layer 20b, and a third electrode layer 20c. First front-surface electrode 20 is a multilayer body of first electrode layer 20a, second electrode layer 20b, and third electrode layer 20c. First electrode layer 20a is arranged on front surface 11. A part of first resistance element 31 is arranged on first electrode layer 20a. Second electrode layer 20b is arranged on first electrode layer 20a. A part of second electrode layer 20b is arranged on first resistance element 31. Third electrode layer 20c is arranged on second electrode layer 20b.

Second front-surface electrode 21 includes first electrode layer 21a, second electrode layer 21b, and a third electrode layer 21c. Second front-surface electrode 21 is a multilayer body of first electrode layer 21a, second electrode layer 21b, and third electrode layer 21c. First electrode layer 21a is arranged on front surface 11. A part of first resistance element 31 is arranged on first electrode layer 21a. Second electrode layer 21b is arranged on first electrode layer 21a. A part of second electrode layer 21b is arranged on first resistance element 31. Third electrode layer 21c is arranged on second electrode layer 21b.

First rear-surface electrode 23 includes first electrode layer 23a, second electrode layer 23b, and a third electrode layer 23c. First rear-surface electrode 23 is a multilayer body of first electrode layer 23a, second electrode layer 23b, and third electrode layer 23c. First electrode layer 23a is arranged on rear surface 12. A part of second resistance element 32 is arranged on first electrode layer 23a. Second electrode layer 23b is arranged on first electrode layer 23a. A part of second electrode layer 23b is arranged on second resistance element 32. Third electrode layer 23c is arranged on second electrode layer 23b.

Second rear-surface electrode 24 includes first electrode layer 24a, second electrode layer 24b, and a third electrode layer 24c. Second rear-surface electrode 24 is a multilayer body of first electrode layer 24a, second electrode layer 24b, and third electrode layer 24c. First electrode layer 24a is arranged on rear surface 12. A part of second resistance element 32 is arranged on first electrode layer 24a. Second electrode layer 24b is arranged on first electrode layer 24a. A part of second electrode layer 24b is arranged on second resistance element 32. Third electrode layer 24c is arranged on second electrode layer 24b.

### Fourth Embodiment

### <Configuration of Chip Resistor>

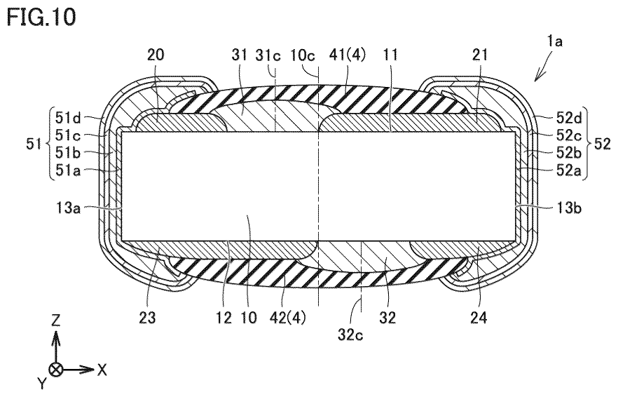

FIG. 10 is a schematic cross-sectional view of chip resistor 1a in a fourth embodiment. FIG. 10 corresponds to FIG. 2. Though chip resistor 1a shown in FIG. 10 is basically similar in configuration and effect to chip resistor 1a shown in FIGS. 1 to 3, it is different in that the sputtered layer is formed also on insulating protective film 4. Specifically, as shown in FIG. 10, first layers 51a and 52a are arranged on first insulating protective film 41 and second insulating protective film 42. Side-surface electrode 5 can thus be formed on insulating protective film 4. Consequently, an area where side-surface electrode 5 extends in the X direction can be adjusted.

### Fifth Embodiment

### <Configuration of Chip Resistor>

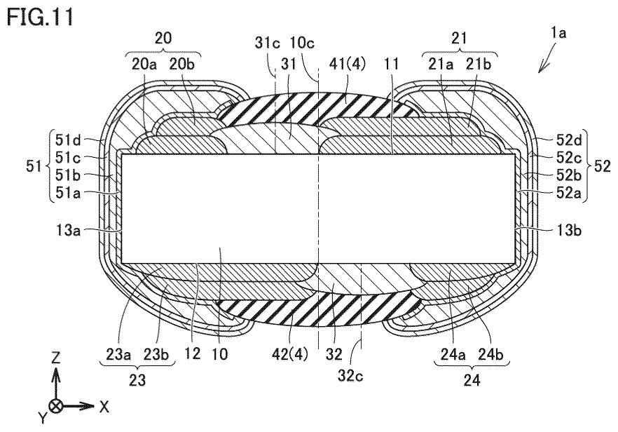

FIG. 11 is a schematic cross-sectional view of chip resistor 1a in a fifth embodiment. FIG. 11 corresponds to FIG. 8. Though chip resistor 1a shown in FIG. 11 is basically similar in configuration and effect to chip resistor 1a shown in FIG. 8, it is different in that the sputtered layer arranged on front-surface electrode 2a and rear-surface electrode 2b each composed of two layers is formed also on insulating protective film 4. Specifically, as shown in FIG. 11, first layers 51a and 52a are arranged on first insulating protective film 41 and second insulating protective film 42. Side-surface electrode 5 can thus be formed on insulating protective film 4. Consequently, the area where side-surface electrode 5 extends in the X direction can be adjusted. As each of front-surface electrode 2a and rear-surface electrode 2b is formed of the two layers, control of angle of inclination θ is facilitated.

### Sixth Embodiment

### <Configuration of Chip Resistor>

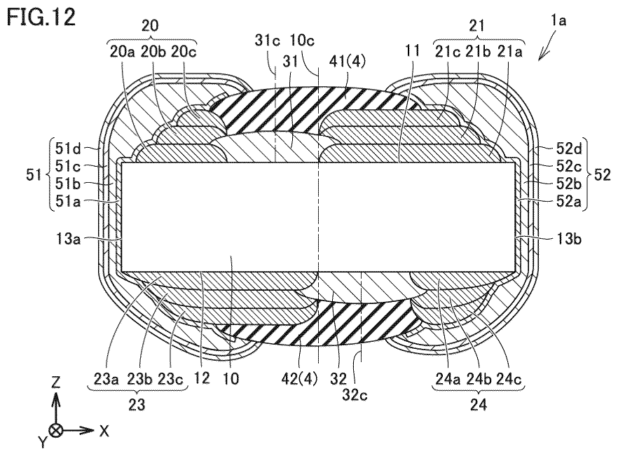

FIG. 12 is a schematic cross-sectional view of chip resistor 1a in a sixth embodiment. FIG. 12 corresponds to FIG. 9. Though chip resistor 1a shown in FIG. 12 is basically similar in configuration and effect to chip resistor 1a shown in FIG. 9, it is different in that the sputtered layer arranged on front-surface electrode 2a and rear-surface electrode 2b each composed of three layers is also formed on insulating protective film 4. Specifically, as shown in FIG. 12, first layers 51a and 52a are arranged on first insulating protective film 41 and second insulating protective film 42. Side-surface electrode 5 can thus be formed on insulating protective film 4. Consequently, the area where side-surface electrode 5 extends in the X direction can be adjusted. As each of front-surface electrode 2a and rear-surface electrode 2b is formed of the three layers, control of angle of inclination θ is facilitated.

### Seventh Embodiment

### <Configuration of Chip Resistor>

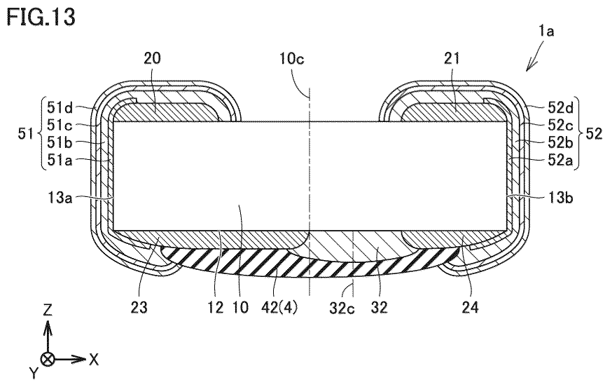

FIG. 13 is a schematic cross-sectional view of chip resistor 1a in a seventh embodiment. FIG. 13 corresponds to FIG. 2. Though chip resistor 1a shown in FIG. 13 is basically similar in configuration and effect to chip resistor 1a shown in FIGS. 1 to 3, it is different in that first resistance element 31 and first insulating protective film 41 are not arranged on front surface 11. The resistance value of chip resistor 1a is thus stable for the long term.

### Eighth Embodiment

### <Configuration of Chip Resistor>

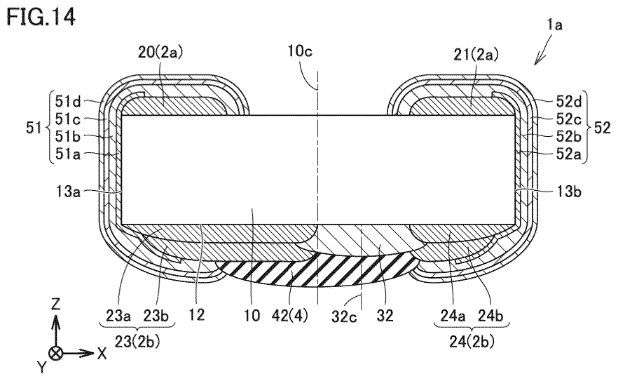

FIG. 14 is a schematic cross-sectional view of chip resistor 1a in an eighth embodiment. FIG. 14 corresponds to FIG. 8. Though chip resistor 1a shown in FIG. 14 is basically similar in configuration and effect to chip resistor 1a shown in FIG. 8, it is different in that first resistance element 31 and first insulating protective film 41 are not arranged on front surface 11. In addition, though front-surface electrode 2a is composed of a single layer, rear-surface electrode 2b is composed of two layers. As rear-surface electrode 2b is composed of two layers, control of angle of inclination θ is facilitated. Since resistance element 3 is arranged only at rear surface 12, the resistance value of chip resistor 1a is stable for the long term.

### Ninth Embodiment

### <Configuration of Chip Resistor>

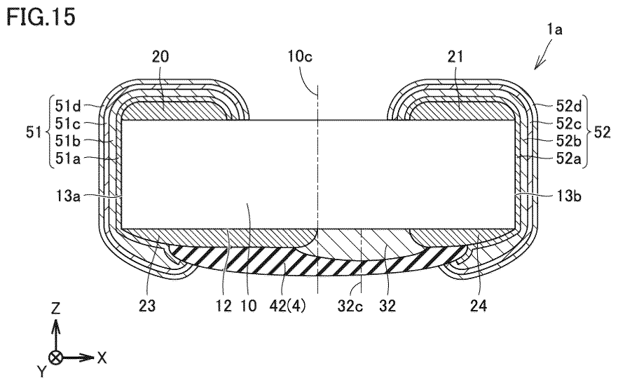

FIG. 15 is a schematic cross-sectional view of chip resistor 1a in a ninth embodiment. FIG. 15 corresponds to FIG. 10. Though chip resistor 1a shown in FIG. 15 is basically similar in configuration and effect to chip resistor 1a shown in FIG. 10, it is different in that first resistance element 31 and first insulating protective film 41 are not arranged on front surface 11. Since resistance element 3 is arranged only at rear surface 12, the resistance value of chip resistor 1a is stable for the long term. First layers 51a and 52a are arranged on second insulating protective film 42. Therefore, side-surface electrode 5 can be formed on insulating protective film 4. Consequently, the area where side-surface electrode 5 extends in the X direction can be adjusted.

### Tenth Embodiment

### <Configuration of Chip Resistor>

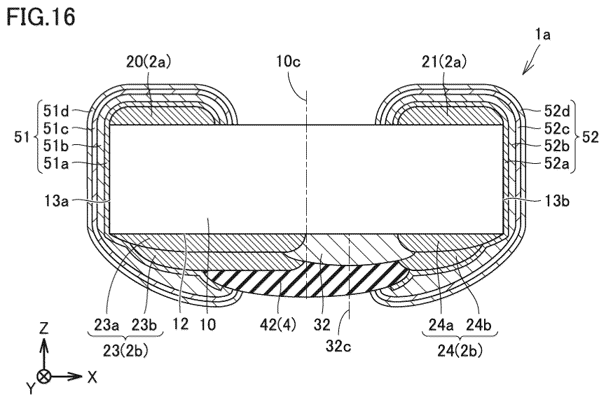

FIG. 16 is a schematic cross-sectional view of chip resistor 1a in a tenth embodiment. FIG. 16 corresponds to FIG. 11. Though chip resistor 1a shown in FIG. 16 is basically similar in configuration and effect to chip resistor 1a shown in FIG. 11, it is different in that first resistance element 31 and first insulating protective film 41 are not arranged on front surface 11. In addition, though front-surface electrode 2a is composed of a single layer, rear-surface electrode 2b is composed of two layers. As rear-surface electrode 2b is composed of two layers, control of angle of inclination θ is facilitated. Since resistance element 3 is arranged only at rear surface 12, the resistance value of chip resistor 1a is stable for the long term. First layers 51a and 52a are arranged on second insulating protective film 42. Therefore, side-surface electrode 5 can be formed on insulating protective film 4. Consequently, the area where side-surface electrode 5 extends in the X direction can be adjusted.

### Eleventh Embodiment

### <Configuration of Chip Resistor>

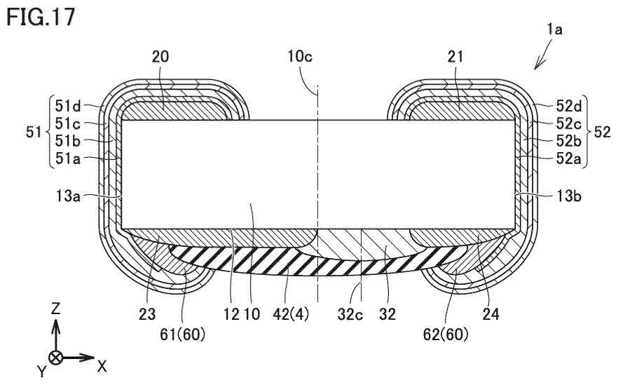

FIG. 17 is a schematic cross-sectional view of chip resistor 1a in an eleventh embodiment. FIG. 17 corresponds to FIG. 13. Though chip resistor 1a shown in FIG. 17 is basically similar in configuration and effect to chip resistor 1a shown in FIG. 13, it is different in that a conductive resin layer 60 is arranged on rear-surface electrode 2b and second insulating protective film 42. Conductive resin layer 60 includes a first conductive resin layer 61 and a second conductive resin layer 62. According to such a configuration, the area in which side-surface electrode 5 extends in the X direction can be adjusted. In addition, occurrence of crack 400 can be suppressed owing to conductive resin layer 60. Consequently, the resistance value of chip resistor 1a is stable for the long term.

First conductive resin layer 61 is arranged on first rear-surface electrode 23 and second insulating protective film 42. Second conductive resin layer 62 is arranged on second rear-surface electrode 24 and second insulating protective film 42. Second conductive resin layer 62 is electrically isolated from first conductive resin layer 61 by second insulating protective film 42.

First conductive resin layer 61 and second conductive resin layer 62 contain resin such as epoxy resin, phenol resin, or a mixture of epoxy resin and phenol resin and conductive particles. Conductive particles are, for example, metallic particles such as silver particles or copper particles, carbon particles, or combination thereof.

### Twelfth Embodiment

### <Configuration of Chip Resistor>

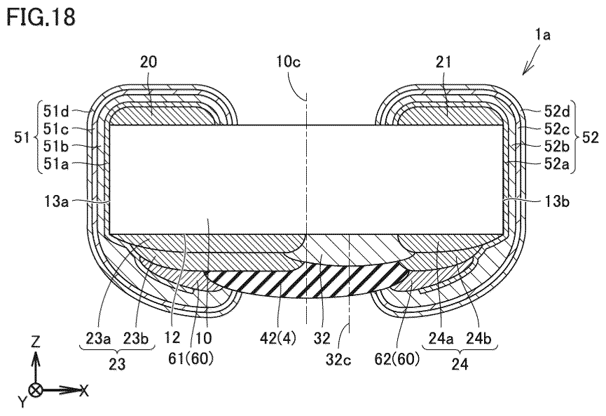

FIG. 18 is a schematic cross-sectional view of chip resistor 1a in a twelfth embodiment. FIG. 18 corresponds to FIG. 14. Though chip resistor 1a shown in FIG. 18 is basically similar in configuration and effect to chip resistor 1a shown in FIG. 14, it is different in that conductive resin layer 60 is arranged on rear-surface electrode 2b and second insulating protective film 42. According to such a configuration, the area in which side-surface electrode 5 extends in the X direction can be adjusted. In addition, occurrence of crack 400 can be suppressed owing to conductive resin layer 60. Consequently, the resistance value of chip resistor 1a is stable for the long term. As rear-surface electrode 2b is composed of two layers, control of angle of inclination θ is facilitated.

First conductive resin layer 61 is arranged on second electrode layer 23b and second insulating protective film 42. Second conductive resin layer 62 is arranged on second electrode layer 24b and second insulating protective film 42. Second conductive resin layer 62 is electrically isolated from first conductive resin layer 61 by second insulating protective film 42.

Various aspects of the present disclosure will be summarized as Additional Aspects below.

### Additional Aspect 1

A chip resistor includes
an insulating substrate including a front surface, a rear surface arranged opposite to the front surface, and a side surface that connects the front surface and the rear surface to each other,
a resistance element arranged at at least one of the front surface and the rear surface,
a rear-surface electrode arranged on the rear surface, and
a side-surface electrode arranged on the side surface and the rear-surface electrode,
with a direction perpendicular to the rear surface being defined as a Z direction,
the side-surface electrode includes a lowermost point arranged at a position most distant in the Z direction from the rear surface,
the side-surface electrode includes a lowermost surface, the lowermost surface being an area from the side surface to the lowermost point,
the lowermost surface is inclined with respect to the rear surface,
the lowermost surface includes a first area including the lowermost point, and
in the first area, an angle of inclination of the lowermost surface with respect to the rear surface is larger than or equal to 1° and smaller than or equal to 10°.

### Additional Aspect 2

In the chip resistor described in Additional Aspect 1,
with a direction perpendicular to the side surface being defined as an X direction,
the lowermost surface includes a second area arranged at a position closest to the side surface in the X direction, and
in the second area, the angle of inclination of the lowermost surface with respect to the rear surface is larger than or equal to 5°.

### Additional Aspect 3

In the chip resistor described in Additional Aspect 2, the lowermost surface includes a third area arranged between the first area and the second area in the X direction, and
in the third area, the angle of inclination of the lowermost surface with respect to the rear surface is larger than or equal to 1° and smaller than or equal to 5°.

### Additional Aspect 4

In the chip resistor described in Additional Aspect 2, in the X direction, the first area has a width at least ½ a distance from the side surface to the lowermost point.

### Additional Aspect 5

In the chip resistor described in any one of Additional Aspects 1 to 4, in a plan view viewed from the Z direction, the rear-surface electrode extends to the side surface.

### Additional Aspect 6

In the chip resistor described in any one of Additional Aspects 1 to 5, a thickness in the Z direction of the rear-surface electrode is larger than or equal to 5 μm.

### Additional Aspect 7

In the chip resistor described in any one of Additional Aspects 2 to 4, a width in the X direction of the side-surface electrode is larger than or equal to 15 μm.

### Additional Aspect 8

The chip resistor described in any one of Additional Aspects 2 to 4 further includes
a front-surface electrode arranged on the front surface, and
an insulating protective film including a first insulating protective film and a second insulating protective film,
the side surface includes a first side surface and a second side surface arranged opposite to the first side surface,
the resistance element includes a first resistance element arranged on the front surface and a second resistance element arranged on the rear surface,
the front-surface electrode includes a first front-surface electrode and a second front-surface electrode arranged at a distance in the X direction from the first front-surface electrode,
the rear-surface electrode includes a first rear-surface electrode and a second rear-surface electrode arranged at a distance in the X direction from the first rear-surface electrode,
the side-surface electrode includes a first side-surface electrode and a second side-surface electrode,
the first side-surface electrode is arranged on the first side surface, the first rear-surface electrode, and the first front-surface electrode,
the second side-surface electrode is arranged on the second side surface, the second rear-surface electrode, and the second front-surface electrode,
the first insulating protective film is arranged on the first resistance element, the first front-surface electrode, and the second front-surface electrode, and
the second insulating protective film is arranged on the second resistance element, the first rear-surface electrode, and the second rear-surface electrode.

It should be understood that the first to twelfth embodiments disclosed herein are illustrative and non-restrictive in every respect. The scope of the present disclosure is defined by the terms of the claims rather than the description above and is intended to include any modifications within the scope and meaning equivalent to the terms of the claims.

### REFERENCE SIGNS LIST

1a, 1b, 1c chip resistor; 2a front-surface electrode; 2b rear-surface electrode; 3 resistance element; 4 insulating protective film; 5 side-surface electrode; 10 insulating substrate; 10c, 31c, 32c center; 11 front surface; 12 rear surface; 13 side surface; 13a first side surface; 13b second side surface; 20 first front-surface electrode; 20a, 21a, 23a, 24a first electrode layer; 20b, 21b, 23b, 24b second electrode layer; 20c, 21c, 23c, 24c third electrode layer; 21 second front-surface electrode; 23 first rear-surface electrode; 24 second rear-surface electrode; 31 first resistance element; 32 second resistance element; 41 first insulating protective film; 42 second insulating protective film; 50s lowermost surface; 51 first side-surface electrode; 51a, 52a first layer; 51b, 52b second layer; 51c, 52c third layer; 51d, 52d fourth layer; 52 second side-surface electrode; 60 conductive resin layer; 61 first conductive resin layer; 62 second conductive resin layer; 100 wiring board; 200 conductive joint member; 400 crack; A1, A2, A3 approximate line; B1, B2, B3 parallel line; L1 first area; L2 second area; L3 third area; P1 lowermost point; T1 thickness; W1, W2 width.

1. A chip resistor comprising:
an insulating substrate including a front surface, a rear surface arranged opposite to the front surface, and a side surface that connects the front surface and the rear surface to each other;
a resistance element arranged at at least one of the front surface and the rear surface;
a rear-surface electrode arranged on the rear surface; and
a side-surface electrode arranged on the side surface and the rear-surface electrode, wherein
with a direction perpendicular to the rear surface being defined as a Z direction,
the side-surface electrode includes a lowermost point arranged at a position most distant in the Z direction from the rear surface,
the side-surface electrode includes a lowermost surface, the lowermost surface being an area from the side surface to the lowermost point,
the lowermost surface is inclined with respect to the rear surface,
the lowermost surface includes a first area including the lowermost point, and
in the first area, an angle of inclination of the lowermost surface with respect to the rear surface is larger than or equal to 1° and smaller than or equal to 10°.

2. The chip resistor according to claim 1, wherein
with a direction perpendicular to the side surface being defined as an X direction,
the lowermost surface includes a second area arranged at a position closest to the side surface in the X direction, and
in the second area, the angle of inclination of the lowermost surface with respect to the rear surface is larger than or equal to 5°.

3. The chip resistor according to claim 2, wherein
the lowermost surface includes a third area arranged between the first area and the second area in the X direction, and
in the third area, the angle of inclination of the lowermost surface with respect to the rear surface is larger than or equal to 1° and smaller than or equal to 5°.

4. The chip resistor according to claim 2, wherein
in the X direction, the first area has a width at least ½ a distance from the side surface to the lowermost point.

5. The chip resistor according to claim 1, wherein
in a plan view viewed from the Z direction, the rear-surface electrode extends to the side surface.

6. The chip resistor according to claim 1, wherein
a thickness in the Z direction of the rear-surface electrode is larger than or equal to 5 μm.

7. The chip resistor according to claim 2, wherein
a width in the X direction of the side-surface electrode is larger than or equal to 15 μm.

8. The chip resistor according to claim 2, further comprising:
a front-surface electrode arranged on the front surface; and
an insulating protective film including a first insulating protective film and a second insulating protective film, wherein
the side surface includes a first side surface and a second side surface arranged opposite to the first side surface,
the resistance element includes a first resistance element arranged on the front surface and a second resistance element arranged on the rear surface,
the front-surface electrode includes a first front-surface electrode and a second front-surface electrode arranged at a distance in the X direction from the first front-surface electrode,
the rear-surface electrode includes a first rear-surface electrode and a second rear-surface electrode arranged at a distance in the X direction from the first rear-surface electrode,
the side-surface electrode includes a first side-surface electrode and a second side-surface electrode,
the first side-surface electrode is arranged on the first side surface, the first rear-surface electrode, and the first front-surface electrode,
the second side-surface electrode is arranged on the second side surface, the second rear-surface electrode, and the second front-surface electrode,
the first insulating protective film is arranged on the first resistance element, the first front-surface electrode, and the second front-surface electrode, and
the second insulating protective film is arranged on the second resistance element, the first rear-surface electrode, and the second rear-surface electrode.
